(19) United States
(12) Patent Application Publication
(10) Pub. No.: US 2024/0370661 A1
(43) Pub. Date: Nov. 7, 2024

(54) GENERATING SUMMARY PROMPTS WITH VISUAL AND AUDIO INSIGHTS AND USING SUMMARY PROMPTS TO OBTAIN MULTIMEDIA CONTENT SUMMARIES

(71) Applicant: MICROSOFT TECHNOLOGY LICENSING, LLC, Redmond, WA (US)

(72) Inventors: Tom HIRSHBERG, Haifa (IL); Yonit HOFFMAN, Herzeliya (IL); Zvi FIGOV, Modiin (IL); Maayan YEDIDIA DOTAN, Ramat Gan (IL); Oron NIR, Herzeliya (IL)

(21) Appl. No.: 18/208,190

(22) Filed: Jun. 9, 2023

Related U.S. Application Data
(60) Provisional application No. 63/499,443, filed on May 1, 2023.

(51) Int. Cl. G06F 40/40; G06F 16/683; G06F 16/783

(52) U.S. Cl. CPC G06F 40/40; G06F 16/685; G06F 16/784

(57) ABSTRACT

Multimedia content is summarized with the use of summary prompts that are created with audio and visual insights obtained from the multimedia content. An aggregated timeline temporally aligns the audio and visual insights. The aggregated timeline is segmented into coherent segments that each include a unique combination of audio and visual insights. These segments are grouped into chunks, based on prompt size constraints, and are used with identified summarization styles to create the summary prompts. The summary prompts are provided to summarization models to obtain summaries having content and summarization styles based on the summary prompts.

### CROSS-REFERENCE TO RELATED APPLICATIONS

This application claims the benefit of and priority to U.S. Provisional Patent Application Ser. No. 63/499,443 filed on May 1, 2023, and entitled “GENERATING SUMMARY PROMPTS WITH VISUAL AND AUDIO INSIGHTS AND USING SUMMARY PROMPTS TO OBTAIN MULTIMEDIA CONTENT SUMMARIES,” and which application is expressly incorporated herein by reference in its entirety.

### BACKGROUND

There is significant interest and value in generating summaries for multimedia content and various techniques have been developed for facilitating processes associated with generating such summaries.

Some conventional techniques for generating summaries rely on user-authored synopsis and the publication of metadata contained within the multimedia content that is being summarized. Some summarization techniques also include the processing of transcripts that comprise textual representations of the audible speech extracted from the multimedia content.

With the development of large language models (LLMs) and other types of machine learning models, it is possible to process and summarize media transcripts via user-directed prompts. A user can, for example, create a prompt that directs a model to summarize the text of a transcript along with the portions of the transcript to be summarized. Unfortunately, the size constraints of existing model prompts can significantly limit the quantity of information that can be provided in a prompt. As a result of these size constraints, it may be impossible to provide the entirety of a transcript to be summarized within a single prompt.

Generating inconsistent summaries is another problem associated with using LLMs and other machine learning models when summarizing multimedia content. In particular, the ability for users to enter different types of instructions and inputs into the prompts of the models, which may be interpreted and processed differently by the models, can significantly alter the results that are generated.

For at least these reasons, it can be difficult to obtain high-quality and reliable summaries of multimedia content from machine learning models, particularly for multimedia content associated with large transcripts.

Any improvements in the manner in which summaries for multimedia content can be obtained, as well as improvements in generating useful prompts for the machine learning models to use when generating the summaries, are desired.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

Disclosed embodiments include methods and systems for generating summaries of multimedia content, as well as for generating summary prompts that contain visual and audio insights that are automatically gleaned from the multimedia content to be summarized. The summary prompts can be used by LLMs and other machine learning models for generating summaries of the multimedia content from which the visual and audio insights are obtained.

In the disclosed embodiments, computer systems process multimedia content, such as videos that contain both audio content and visual content. During this processing, the computer systems generate summary prompts containing audio insights from the audio content and visual insights from the visual content. The audio insights may include a coherent transcript that includes textual representations of the spoken utterances contained in the audio content, identifications of speakers of the spoken utterances, and/or other speech attributes associated with the spoken utterances. The audio insights may also include labels corresponding to nonspeech sounds. The audio insights can be generated by the systems performing speech-to-text and diarization processing on the audio content, as well as by performing other audio processing on the audio content with models trained to perform the audio processing.

The visual insights may include any combination of (i) text visualized in the visual content, (ii) object labels for objects visualized in the visual content, and/or (iii) identity labels for people represented in the visual content. The visual insights can be generated by the systems performing facial recognition and object recognition on the visual content, as well as by performing other image processing on the visual content with models trained to perform the image processing and by, optionally, removing duplicate visual insights identified. In some instances, an optical character recognition (OCR) model is used to identify text displayed in the visual content, such as media banners, branding on displayed products, signs, and other displayed text.

The systems also generate an aggregated timeline of the audio insights and the visual insights which temporally aligns the audio insights and the visual insights. This aggregated timeline is segmented into a plurality of coherent segments, wherein each of the coherent segments includes a unique combination of audio insights and visual insights. For streaming data, the aggregated timeline can be processed and segmented as one or more discrete portions of the streaming content of a predetermined duration of time.

The processing of the multimedia content also includes grouping the coherent segments into a set of chunks, with the number of segments being combined into any particular chunk being based on a predetermined prompt size of a model for which the summary prompts are to be created. In some instances, two temporally adjacent chunks in the set of chunks are linked together with a linking segment that is included in both temporally adjacent chunks. This can facilitate the linking of corresponding summary prompts and responsive summaries.

The systems also identify a selected summarization style that is implicitly or explicitly selected from a plurality of different summarization styles.

Finally, a summary prompt is generated for each chunk in the set of chunks, which includes (i) the audio insights and visual insights of the coherent segments of each chunk and (ii) the selected summary style.

Some of the disclosed techniques also include the systems providing the summary prompts to a model, such as an LLM or another machine learning model that is trained to generate summaries based on summary prompts. The systems also receive responsive summaries back from the model(s) after providing the summary prompts to the model(s). The summaries have content and summarization styles based on the summary prompts.

In some instances, a new summary prompt is generated by combining a plurality of responsive summaries based on different summary prompts that were created for the same multimedia content. The new summary prompt is then used to obtain a new summary based on the plurality of responsive summaries by providing the new summary prompt to a summarization model, such as the model used to generate the responsive summaries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a processing flow that includes multimedia content comprising a video file being processed by image processing models and audio processing models to generate corresponding visual insights and audio insights for the multimedia content.

FIG. 2 illustrates another example of the processing flow of FIG. 1.

FIG. 3 illustrates an example of a processing flow that includes multimedia content comprising a video file being processed to generate summary prompts and summaries based on visual insights and audio insights for the multimedia content.

FIG. 4A illustrates an example of a set of chunks being formed from groupings of scene segments and which are used to form corresponding prompts and which are further used to obtain responsive summaries.

FIG. 4B illustrates another example of a set of chunks being formed from groupings of scene segments and which are used to form corresponding prompts and which are further used to obtain responsive summaries.

FIG. 5 illustrates an example of a processing flow that includes multimedia content comprising a video file being processed to generate summary prompts and summaries based on visual insights and audio insights for the multimedia content and in which the processing flow further includes extractive summarization processes.

FIG. 6 illustrates an example of a flowchart having acts associated with methods for generating summary prompts and summaries for multimedia content based on visual insights and audio insights for the multimedia content.

FIG. 7 illustrates another example of a flowchart having acts associated with methods for generating summary prompts and summaries for multimedia content based on visual insights and audio insights for the multimedia content.

### DETAILED DESCRIPTION

As noted, the disclosed embodiments include methods and systems for generating summaries of multimedia content, as well as for generating summary prompts that contain visual and audio insights gleaned from the multimedia content to be summarized. The summary prompts can be provided to LLMs and other machine learning models for generating summaries of the multimedia content.

The disclosed embodiments provide many technical benefits over conventional media summarization techniques. For example, in some instances, the disclosed summarization techniques enable the generation of summary prompts and summaries based on multimedia content that includes transcripts that are too large to be entered into any single model prompt. This is possible, with the disclosed techniques, by generating chunks of coherent segments that include visual insights and audio insights for different portions of the multimedia content to be summarized. Then, the summaries that are obtained from summary prompts based on the chunks are subsequently linked together into a new prompt for generating a comprehensive summary based on all of the underlying chunk summaries. This technique enables the generation of a comprehensive summary of multimedia content, regardless of the size constraints of the model prompts.

Additionally, by including visual insights into the prompt along with audio insights, which may include labels for nonspeech sounds, for example, it is possible to obtain higher-quality summaries that contain more rich information than is possible when generating summaries with conventional systems that rely solely on transcripts of detected speech.

The use of summary prompts, in the manner described, also facilitates flexibility for adjusting a style of summary to be generated, while also promoting consistency and reliability for generating the summaries within each style, by enabling the chunks to include the identification of a selected summarization style along with the insight data for the coherent segments that are combined into each of the chunks.

The summary prompts are generated, in some embodiments, by a computer system that includes one or more processors, including at least one hardware processor, and a storage device having stored executable instructions that are executable by the processor(s) for causing the computer system to implement the disclosed functionality for accessing and processing the multimedia content to generate corresponding summary prompts and summaries.

The computer systems include input devices, such as keyboards, mice, touch screens, microphones, cameras, and software interfaces for receiving inputs (e.g., summary prompts and instructions) and for accessing the multimedia content to be processed. The computer systems also include output devices, such as display screens and speakers. Software interfaces can also be used for rendering outputs (e.g., summaries).

As described herein, multimedia content is summarized with the use of summary prompts that are created with audio insights and visual insights obtained from the multimedia content. The multimedia content can be a video file or another type of media file that contains any combination of audio content and/or visual content. In some instances, the multimedia content is a video file having both audio content and visual content. The textual data referenced herein (e.g., subtitles and transcripts) can be stored with the media file or stored separately in a separate file.

The multimedia content may be stored as a single file accessible from a single storage location. The multimedia content can also be a distributed file with discrete portions that are accessible from multiple disparate locations. In some embodiments, the multimedia content has a finite size (e.g., a fixed quantity of images or frames and/or a fixed duration of audio). In some embodiments, the multimedia content comprises streaming data that does not have a predetermined size or duration while it is being processed and streamed in real-time, although it may later be saved with a finite size into one or more storage locations. When the multimedia content is being streamed, it can be segmented into discrete portions of a predetermined size or duration (e.g., one-hour segments or segments of another duration of time) during the streaming of the multimedia content (prior to the totality of the multimedia content having been received) and/or after the streaming of the multimedia content has concluded.

As described, the disclosed systems process multimedia content to generate audio insights and/or video insights about the multimedia content to be summarized. The audio insights may include, for example, (i) a coherent transcript of speech contained in the audio along with speaker identifications for the speech, and/or (ii) labels for nonspeech sounds. The visual insights may include (i) text shown in the visual content (e.g., signs, branding on visualized products, and media banners), (ii) object labels of visualized objects, and/or (iii) identity labels for people represented.

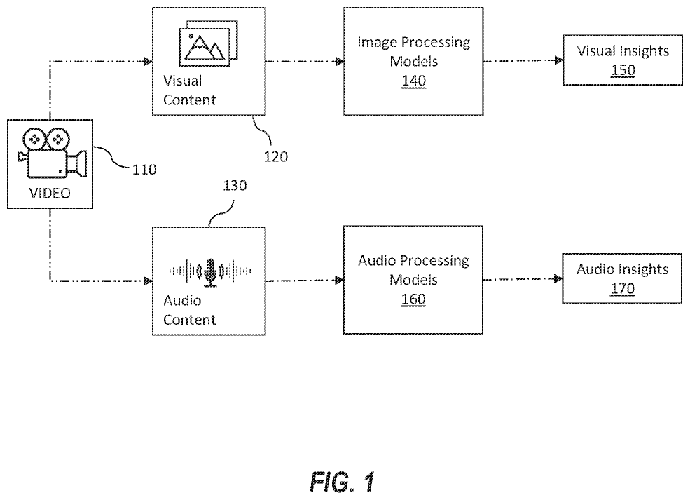

The computer system may interface with and/or incorporate different machine learning models that are trained with training data to perform the described and referenced functionality. For example, a trained speech-to-text model can be applied to the audio content to generate a transcript of textual representations of the speech contained in the audio content. Similarly, a trained facial recognition model can be applied to the visual content to generate identification labels that identify people that are represented in the visual content. Additional examples will be provided in the following description of FIGS. 1-7.

Attention is now directed to FIG. 1. In this illustration, multimedia content is a file comprising video 110, which contains both visual content 120 and audio content 130. The visual content 120 may include images represented as stand-alone images, as well as sequences of images or sequential frames that comprise animations. The audio content 130 may include audio in the form of speech, as well as nonspeech audio (e.g., animal sounds, mechanical sounds, sounds of physical reactions, etc.).

As shown, the visual content 120 is processed by one or more image processing models 140 that are applied to the visual content 120 to generate visual insights 150. Similarly, audio content 130 is processed by one or more audio processing models 160 that are applied to audio content 130 to generate audio insights 170. The video insights 150 and the audio insights 170 may be represented as textual labels, as well as textual recitations from a transcript, for example, that are capable of being entered into a text prompt of an LLM or another summarization model.

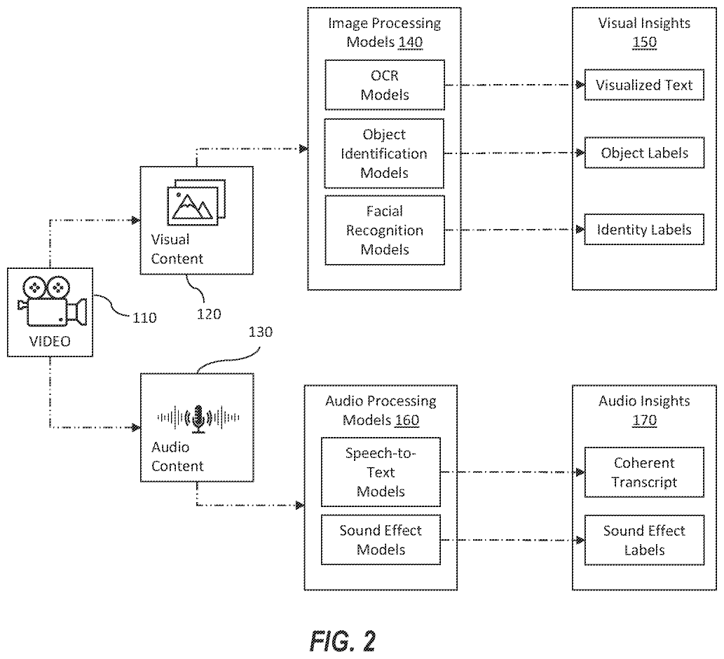

As shown in FIG. 2, image processing models 140 may include OCR models trained to recognize text within images, object detection models trained to identify objects represented in images, and facial recognition models trained to recognize faces and people represented in images.

The visual insights 150 obtained from the visual content 120 include the text identified by the OCR models from the visual content 120, as well as object labels generated by the object identification models for objects identified in the visual content 120. The visual insights 150 may also include identity labels comprising names or other identifiers (e.g., titles, characterizations, or other identifiers) for people that are identified in the visual content by the facial recognition models.

Other visual insights 150 can also be obtained and used for generating summary prompts, such as labels for gestures or symbols that are detected from the visual content by gesture identification models (not shown). By way of example, a gesture identification model can detect sign language presented in the visual content 120 and can present labels and/or transcripts for the detected sign language which may be used as a visual insight.

FIG. 2 also illustrates how the audio processing models 160 may include speech-to-text models trained to convert audio content comprising spoken utterances (i.e., speech) into a transcript of textual representations of the spoken utterances. The speech-to-text models may also perform diarization processes on the speech to associate different speakers to different spoken utterances, as well as to identify line breaks between different spoken utterances to facilitate the grammatical presentation and flow of the transcript. The line breaks, speaker identifications, and textual representations of the spoken utterances are all audio insights 170 that can be combined and represented within a single coherent transcript. Such a transcript can be presented in its entirety within a single summary prompt or, alternatively, the transcript can be broken into logical portions that are temporally aligned with and linked to other visual and audio insights within coherent segments.

Although not shown, the audio processing models 160 may also include other types of models and functionality, such as translation models that are configured to translate spoken utterances from one language to another. This can be particularly helpful, for example, when the audio content contains speech in multiple languages. In such instances, the coherent transcript that is generated to represent the spoken utterances may also include language descriptors or labels that reflect the language(s) in which the spoken utterances were presented in the audio content 130. The coherent transcript may also reflect other speech attributes of the spoken utterances (e.g., accents, volume, rate of speech, style).

The audio processing models 160 may also include models that are configured and trained to identify and label nonspeech audio elements in the audio content (e.g., animal sounds, machine sounds, and sounds of physical reactions). The labels generated for the sound effects or other nonspeech audio elements can be used as some of the audio insights 170 that are used to generate the referenced summary prompts.

In some instances, the image processing models 140 and the audio processing models 160 are trained on domain-specific or enterprise-specific sets of training data corresponding to a particular domain or enterprise, to facilitate more accurate labeling of the detected image and audio elements that are labeled as corresponding visual insights and audio insights.

By way of example, the speech-to-text models are configured to reference acoustic libraries of voice and other speech attributes associated with different speakers from a particular enterprise to find correlations between those different speakers and the spoken utterances in the audio content. Likewise, facial recognition models may be trained on a set of training data for a particular set of people known to a company or industry (e.g., celebrities), to facilitate the identification of those people that are represented in the multimedia content being processed.

Another example of training a model on a domain-specific set of training data includes training a nonspeech sound model on a domain of a specific species of animal sounds (e.g., birds or mammals) to facilitate the identification of those types of animal sounds from the audio content.

The models can also be trained on and/or use user preference data to determine the importance or relevance of insights that are detected and stored. Additionally, or alternatively, user preferences can be used to filter which insights provided by the models are ignored or, alternatively, stored in the data structures that store the visual insights 150 and the audio insights 170.

The visual insights 150 and the audio insights 170 that are detected and stored by the systems are stored in reference tables or other data structures that enable indexing and searching of the insights by their relative or absolute temporal locations within the multimedia content. This is beneficial for filtering which data is stored and for correlating the relative timing of the detected insights into an aggregated timeline of insight data for the multimedia content.

In some instances, for example, the systems will check whether particular insight data is already identified and stored for a particular segment or range of time within the multimedia content before determining whether to record a newly identified insight for that segment or range of time.

By way of example, when a nonspeech sound is detected for a particular segment of audio content (e.g., a particular scene of a movie or another segment of the multimedia content), the system may determine whether that sound has already been documented or stored for that particular segment of the multimedia content. If it has, then the system may refrain from storing or indexing the same sound a second time for that particular segment. This can help prevent recording duplicates of the same information for common segments of the multimedia content and can, therefore, help prevent undesired biasing of the detected insights that may persist over multiple frames or durations of time within a single segment of the multimedia content. This can be particularly helpful, for example, when the image content includes a banner or brand icon that is persistently displayed in all of the images of a video (e.g., the CNN icon presented during a video of a CNN newscast).

In other instances, the systems may record all insights that are detected and reported by the different models. This can be beneficial when the models are independently trained to output insight data at periodic intervals and/or to output insight data that is determined by the model to exceed a trained relevance threshold, irrespective of timing, when the relevance threshold decreases for duplicate insight data.

Regardless of how the systems obtain the insight data from the models, or whether the models are capable of independently filtering the insight data, the systems will preferably filter the received and/or stored insights to remove duplicates that are detected within any predetermined segment of the multimedia content.

The systems may segment the multimedia content and/or aggregated timeline of the insights based on a temporal segmentation, such as based on predetermined durations of time (e.g., minutes, hours, or other durations of time) and/or a size segmentation, such as based on a quantity of data being stored (e.g., a predetermined quantity of sequential frames or images, or bytes of data). The segments may also be defined by a logical and nontemporal segmentation scheme that is not necessarily based on the time or size of the content. Some examples of logical partitioning include segmenting by chapter, scene, act, or topic. In some instances, models trained to create segments are applied to the multimedia content to create the different segments. Generic AI models can also be used to generate segments. Examples of models that may be used include the Segment Anything Model (SAM), OpenAI's Whisper, Generative Pre-trained Transformer 3 (GPT-3), and Natural Language Toolkit (NLTK) Text Tiling. Semantic Scene Segmentation algorithms can also be used to automatically perform the segmentation.

In other instances, the multimedia content is created with tags and metadata that identify different segment breaks. The segmentation of the multimedia content can be performed by a combination of logical segmentation, and/or temporal segmentation, and/or size segmentation.

When the multimedia content comprises streaming data, the systems will segment the multimedia content, as it is received and processed, into segments of a predetermined duration of time or a predetermined size.

Regardless of how the multimedia content is segmented, the systems will identify and index visual insights 150 and audio insights 170 for the visual content 120 and the audio content 130 within each of the different segments of the multimedia content where the insights are identified. The indexed insights will also include information that can be used to temporally align and link the visual insights 150 and the audio insights 170 to the different segments that are created before and/or after indexing the multimedia content.

The systems use this information to generate an aggregated timeline that correlates the different visual insights 150 and audio insights 170 by temporal relationships within the data structures that store the insights. In particular, the systems will index the different visual insights 150 and audio insights 170 according to the relative or absolute temporal locations in which they occur within the multimedia content. A relative location may include a particular scene, or other classified portion of the media, such as an introduction, conclusion, credits, etc. The absolute location may be specified by a timestamp (e.g., at timestamp n, or in a range of time such as between timestamp x and timestamp y, etc.). The temporal locations of the different insights can be indexed at any desired level of specificity or granularity.

The image processing models 140 and the audio processing models 160 may be directly incorporated into the systems that use the visual insights 150 and the audio insights 170. In other instances, the image processing models 140 and the audio processing models 160 are third-party systems that are accessed and used by the disclosed systems to obtain the disclosed visual insights 150 and audio insights 170.

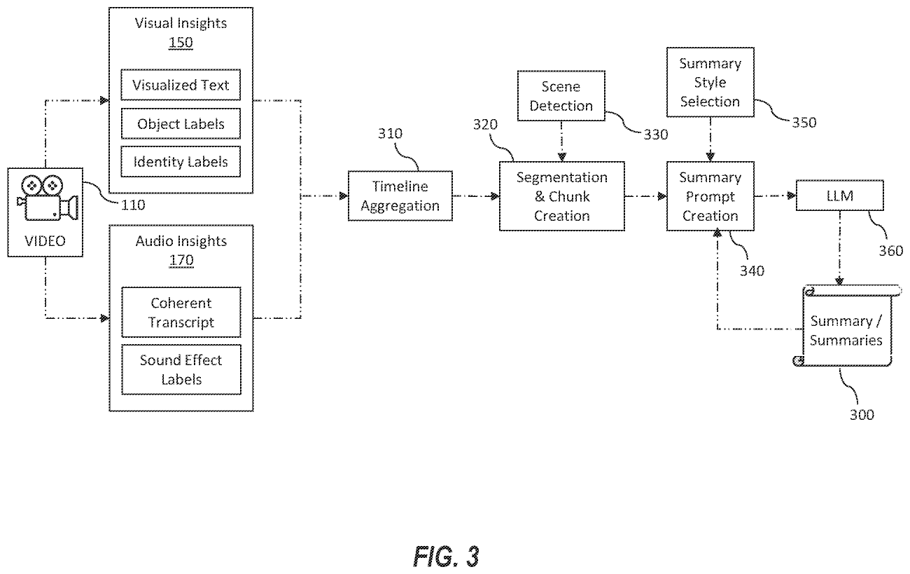

Attention is now directed to FIG. 3. In this illustration, a processing flow is presented that shows visual insights 150 and audio insights 170 for video 110 being processed to generate summary prompts and corresponding summaries for the video.

As shown, a timeline aggregation 310 is performed on the visual insights 150 and audio insights 170. This process may include indexing the temporal locations of the visual insights 150 and audio insights 170 into existing tables, indexes, or other data structures that store the visual insights 150 and audio insights 170. In this case, the existing data structures already include the aggregated timeline of the visual insights 150 and audio insights 170 and the aggregated timeline is merely updated. The timeline aggregation may alternatively include generating a separate and new data structure that sequences the visual insights 150 and audio insights 170 into a new aggregated timeline data structure.

Segmentation and chunk creation processes are also performed. This may include breaking the aggregated timeline into separate coherent segments based on logical or structured partitions. As noted earlier, the partitioning of the coherent structure may be based on different logical, temporal, and size constraints. In some instances, this includes segmenting the aggregated timeline by scene, chapter, act, or other partition (e.g., one-hour segments). For instance, the system may perform scene detection 330 on video 110 to identify logical partitions (i.e., scenes) for segmenting the video. Scene detection 330 may be performed by a model that is trained in scene detection. In other instances, scene detection 330 is performed by analyzing metadata included with the multimedia that identifies different scenes.

It will be appreciated that segmentation of the multimedia may be performed concurrently with or as a part of the timeline aggregation process. In some instances, the multimedia content is segmented first and then aggregated per segment into an aggregated timeline for each segment. This may also include grouping the different segments into chunks of predetermined chunk sizes for which different prompts will be created. Either way, the timeline aggregation and segmentation result in a plurality of coherent and grouped chunks of segments. As noted earlier, the segmenting and grouping can be performed by scene or other logical or temporal segmentation scheme, from a single composition of multimedia content (e.g., video 110 or another composition of multimedia content) that is to be summarized. Each of the plurality of coherent segments will also include the visual insights 150 and audio insights 170 that are temporally aligned and located within that segment.

As mentioned earlier, some LLM prompts have size constraints that restrict the ability to enter the entirety of a transcript and/or other information into the prompts. The segmentation of the multimedia content and corresponding insights helps to address this problem. In particular, in some instances, the size or duration of each segment is determined to be a size or duration in which all of the visual insights and image insights for that segment can be contained within the size constraints of a model prompt that will be used to generate a summary. For instance, the system may consider the size constraints of the prompt when determining how big to make each of the segments.

In other instances, if the size or duration of a segment is made before assessing the size limits of the prompt, and the generated segment is determined to be too large for the prompt (i.e., all the visual insights and image insights for that segment will not fit within the prompt), then the system may retroactively filter some of the insights that are determined to be less relevant, such that the resulting filtered amount of information (e.g., labels, transcript recitations, and other insights) that remains for the segment will be less than the size constraint of the model prompt.

The system may include filters that have rules and training logic that is trained to identify and filter out less relevant information and noise from the segments, when necessary to accommodate the size constraints of the LLM or other summarization model prompts. By way of example, the filtering may include de-duplication of identified visual insights and image insights that are already identified for a particular segment. By refraining from using duplicate audio insights and video insights for a particular segment, it is possible to avoid over-saturating a summary with themes based on the duplicate information. In some instances, only the duplicate visual insights are omitted for a segment, while audio insight duplicates can be used. This can be helpful to ensure the summary is primarily based on what is talked about in the multimedia content, with some reference to what is shown, and without overly emphasizing what is shown in the summary. Alternatively, if a user wants to have more emphasis on what is shown, the system can be configured to treat audio insight and video insight duplicates the same.

In some embodiments, the systems are configured to store and use a threshold number of duplicate video insights and/or audio insights per segment when making the summaries (e.g., no more than two duplicates per segment, no more than three duplicates per segment, no more than four duplicates per segment, no more than five duplicates per segment, no more than another number of duplicates per segment that is greater than five).

The filtering may also include referencing an exclusion listing of labels that are to be excluded from use when they are identified in the audio insights and video insights. Additionally, or alternatively, the filtering may include referencing an inclusion listing of labels that should be included when they are identified in the audio insights and video insights. These listings can be provided by an end-user or third party to help control the information that is used when generating the summaries. For example, by including certain topics or types of information to be excluded, the system can eliminate noise in the summary that may otherwise reference the topics and types of information to be excluded. By identifying topics or types of information to be included with an inclusion listing, it is possible to control the generation of summaries that are more likely to include references to certain types of information that is identified to be of interest when it is detected in the multimedia.

The filtering mentioned herein can be proactive or reactive. In particular, proactive filtering includes the active refraining from storing audio insights and video insights that are identified by the system during the analysis of the multimedia content but that has also been identified as insights that should be excluded (e.g., insights identified in the exclusion listing). Proactive filtering can also include actively refraining from storing a new reference to an audio insight or video insight that is already stored when de-duplication filtering is applied.

Reactive filtering, on the other hand, can include deleting stored entries of the audio insights and video insights that were previously identified and cached or stored during the processing of a particular segment. In particular, this reactive filtering may be based on a subsequent reference to an exclusion listing, for example, after the audio insights and video insights are first obtained and stored for the different segments. Reactive filtering may also include deleting duplicates for a particular segment when de-duplication filtering is applied.

While the foregoing descriptions of segmenting and filtering may refer to video content. It will also be appreciated that related methods can also be applied to any media that includes multiple dimensions (e.g., images, texts, video clips), such as webpages, PowerPoint decks, etc. Notably, when the multimedia comprises any of these non-traditional video media types, the systems may still apply the referenced pre-generative model processing to perform segmentation of the multimedia and to identify different video insights and audio insights that are contained within each of the different segments.

By way of example, when considering a webpage, rather than serializing and segmenting the multimedia content based on time, the webpage can be serialized and segmented based on positional and vertical or horizontal alignment (e.g., a first segment can be the top portion of the webpage, the next segment can be the middle portion of the webpage and the next segment can be the bottom of the webpage). Different positional segmentation can also be used (e.g., from left to right, right to left, bottom to top, edge to center, and center to edge). Rather than only positional alignment, it is noted that the types of elements included in the webpage can also be used as a basis for performing segmentation and for defining a coherent segment (e.g., content in a video frame, text contained in a text frame, and links).

By way of yet another example, a PowerPoint deck could be processed and segmented slide by slide to identify different audio insights and video insights for each slide, such that the system can generate an overall summary based on the individual summaries generated for each slide.

With regard to the size of the segments, it is noted that the system may break a segment into multiple smaller segments until all of the segments corresponding to the multimedia content being processed are all sized small enough to each fit within the model prompt.

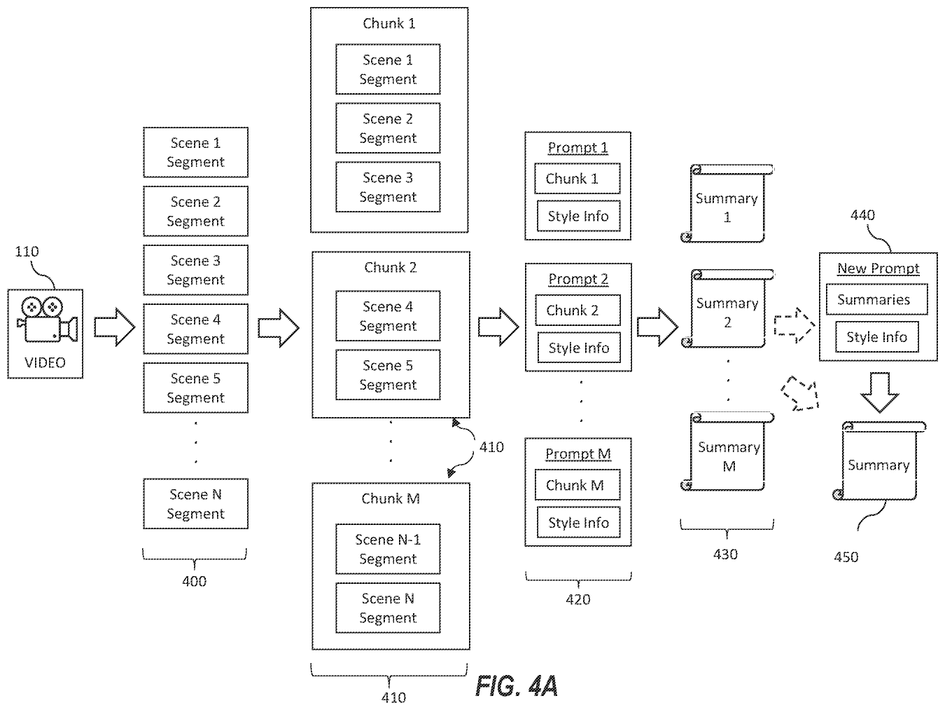

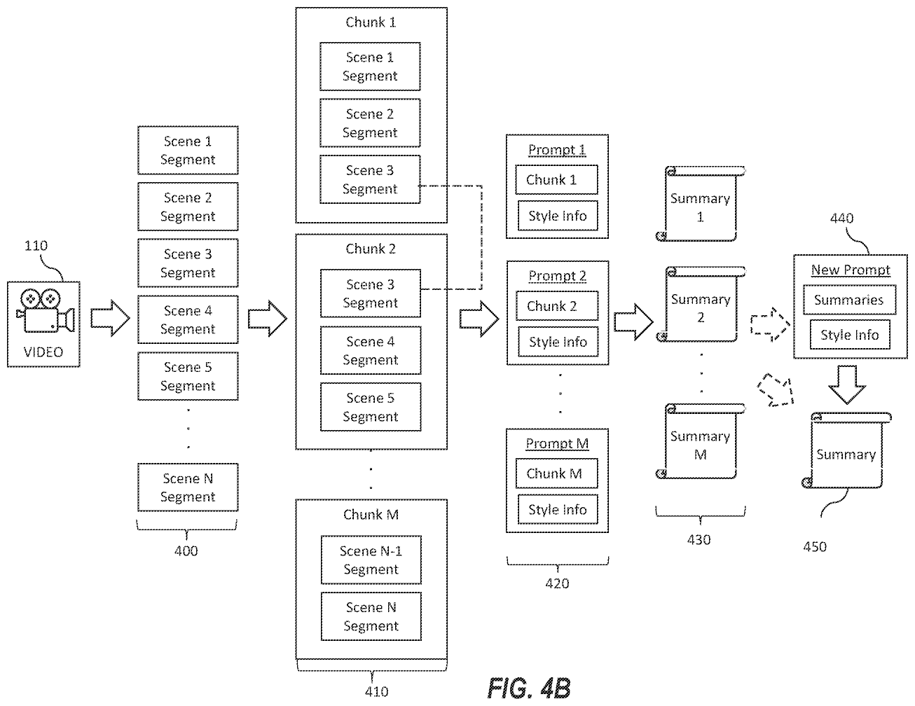

In some instances, when it is possible to combine multiple segments (including all of their insight data) within a single model prompt, the system may combine the multiple segments into chunks. This is shown in FIGS. 4A and 4B.

As illustrated in FIG. 4A, video 110 is segmented into a plurality of coherent segments 400 that were formed during the segmentation process based on scenes (e.g., Scene 1 Segment, Scene 2 Segment, Scene 3 Segment, Scene 4 Segment, Scene 5 Segment . . . Scene N Segment). Each of these coherent segments 400 includes visual insights and audio insights that are temporally aligned within each of the respective segments, as previously discussed.

The determined prompt size of an LLM model or other model that will receive the summary prompts is determined by the system to be large enough to accommodate two or more of the coherent segments 400. Accordingly, the system, upon making this determination, will generate a set of chunks 410 during the segmentation & chunk creation processes (320) with each chunk comprising a grouping of two or more of the coherent segments. The size of each chunk may vary, as may the size of each segment.

The system will determine how many of the coherent segments 400 to group into each chunk based on the model prompt size constraint, such that each chunk only contains a limited grouping of coherent segments (which includes the visual and audio insights for those segments) that can collectively fit within the model prompt. In some instances, the systems also make sure that the grouping of segments within each chunk will also leave enough room to accommodate the identification of a summarization style that is preferred when generating the summary.

With regard to summarization styles, it will be appreciated that summaries can be presented in many different ways (with different styles), such as a storytelling style, informative newscast style, academic research presentation style, persuasive debate style, or any number of other styles. The styles may also be based on age appropriateness, such as a child-appropriate style, mature content or language style, etc. The styles may also be based on language type (e.g., English, Spanish, Mandarin). The LLM 360 or another summarization model that is performing the summarization can be trained on different training data sets of different language styles to present summaries and other requested information in the different styles, including a selected style from the plurality of different styles, wherein a selected style may comprise different combinations of styles.

In some embodiments, the LLM 360 is a commercially available generative artificial intelligence model. Some examples of generative artificial intelligence models include Language Model for Dialogue Applications (LaMDA), Pathways Language Model (PaLM), Large Language Model Meta AI (LLaMA), Generative Pre-trained Transformer (GPT)-3, GPT-4, and Bidirectional Encoder Representations from Transformers (BERT).

In some instances, the systems provide selectable interface objects (not shown), that a user may select when generating a summary prompt and which, when selected, will auto-populate a textual description of a selected summary style within the summary prompt during the summary prompt creation 340.

In other instances, the users are provided a legend of keywords, labels, or phrases (which are predetermined to identify different styles to the model(s)) and which the user may enter into the prompt, or provide to the system, to identify the selected summary style(s) desired. Any of the foregoing techniques may be used to perform the referenced summary style selection 350 shown in FIG. 3 and which is performed for enabling a system to identify or select a desired summary style from a plurality of different available summary styles.

As mentioned, the disclosed systems use the foregoing summary style information during the summary prompt creation 340 by combining the identified summary style information with the visual and audio insights of the segments that are grouped in a particular chunk for which the summary prompt is created. In some alternative embodiments, the systems create the summary prompt without any summary style information and, instead, let the LLM 360 or other summarization model determine which summarization style to use when generating the corresponding summaries 300.

Returning now to FIG. 4A, each chunk in the set of chunks 410 is processed during the summary prompt creation to create a corresponding summary prompt, thereby creating a plurality of summary prompts 420 that all correspond to the same composition of multimedia content (e.g., video 110) that is being processed and for which a summary is desired.

Once the summary prompts 420 are created, they are provided or entered as prompts (or into prompt input fields) of an LLM 360 or another model that further processes the visual and audio insights for the segments of the corresponding chunk and that creates a summary for that corresponding chunk in a desired style (e.g., that was identified within the summary prompt). Through this process, the system receives a plurality of response summaries 430 back from the LLM that corresponds to the different chunk prompts 420.

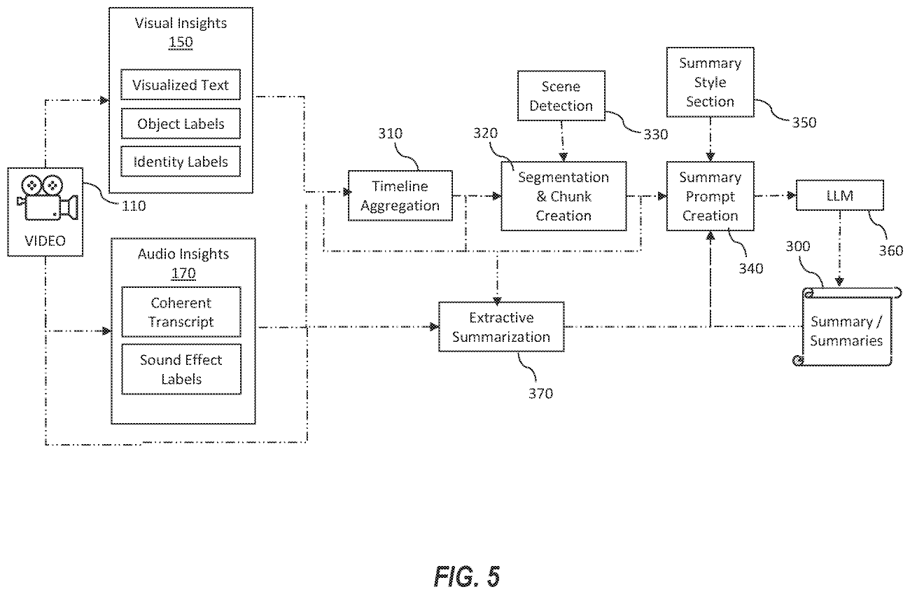

Thereafter, the system may generate a new prompt 440 that is based on and/or that explicitly includes all of the content from all of the response summaries 430. In alternative embodiments, the response summaries 430 are processed by an extractive summarization module that is trained to perform extractive summarizations of content (e.g., to summarize a block of text into a single set of one or a few sentences that is less than the entirety of the block of text). Then, the system may provide the extractive summaries of each of the response summaries 430 as input into the new prompt 440, with or without summarization style information. The extractive summarization process can also be performed earlier while generating the original summary prompts, as will be described below in reference to FIG. 5.

Once the new prompt 440 is generated, it can be provided to the summarization model to obtain a final comprehensive summary 450 of video 110 or other multimedia content being summarized.

In some alternative embodiments, the final comprehensive summary 450 can also be generated by simply concatenating all of the different response summaries together, without generating a new prompt or seeking to re-summarize the contents of the different response summaries 430. This can be particularly beneficial when a user wants to generate a comprehensive summary that gives a different summary for each segment or scene of the multimedia content.

Attention is now directed to FIG. 4B, which is similar to the embodiment of FIG. 4A. However, in this embodiment, the chunk creation process includes linking two temporally adjacent chunks together with a linking segment. For example, as shown, the Scene 3 Segment of Chunk 1 is also included in Chunk 2 in FIG. 4B, whereas it was not in FIG. 4A. This duplication of the Scene 3 Segment for inclusion in both Chunk 1 and Chunk 2 creates a link between the different temporally adjacent chunks. This type of linking can be beneficial for scenarios in which there is no strong logical partition or break between the different scenes or segments. Then, when the response summaries 430 are received in response to the different chunk prompts 420, Summary 1 will include transition language that links Summary 1 to Summary 2. This can help facilitate generating a cohesive summary when directly concatenating the response summaries 430, for example, by facilitating the creation of transition language between the different response summaries 430.

Attention is now directed to FIG. 5. This illustrated processing flow is similar to the processing flow described above concerning FIG. 3 for generating summary prompts and corresponding summaries 300. Notably, the referenced summaries 300 can include any of the response summaries 430 and comprehensive summaries (450) described in FIGS. 4A-4B.

In FIG. 5, the illustrated processing flow for generating summary prompts and corresponding summaries additionally, or alternatively, includes extractive summarization 370. This type of specialized summarization process was previously described in reference to summarizing response summaries. Notably, this process includes summarizing text (e.g., a transcript and/or other audio insights and visual insights) into one or a few sentences that are less than the total amount of data being summarized. An extractive summarization module may be used by the systems to generate extractive summaries that are included in summary prompts with or without summary style information and which are provided to the LLM 360 or another model to generate the referenced summaries 300.

The extractive summaries may be based entirely on the transcript, in some embodiments, thereby omitting other audio and visual insights from the summary prompts. This embodiment can be particularly beneficial when a system is not configured to generate other audio insights or video insights and/or when a user wants a summary based solely on the transcript. The transcript that undergoes the extractive summarization 370 can also be processed with any combination of the other audio insight data or visual insight data that has been described herein and which may be temporally aligned within different segments that are each used to generate a separate extractive summary from. Then, the different extractive summaries for each segment of a plurality of different segments can be combined into a single extractive summary by concatenating all of the different extractive summaries in their entirety, or by performing a subsequent extractive summarization of the combined extractive summaries.

The extractive summaries can then be routed to the LLM 360 via summary prompts that comprises the extractive summaries. Then, once the summaries 300 are received by the LLM 360, they can undergo further extractive summarization 370 to generate a final extractive summary, if desired, although not shown.

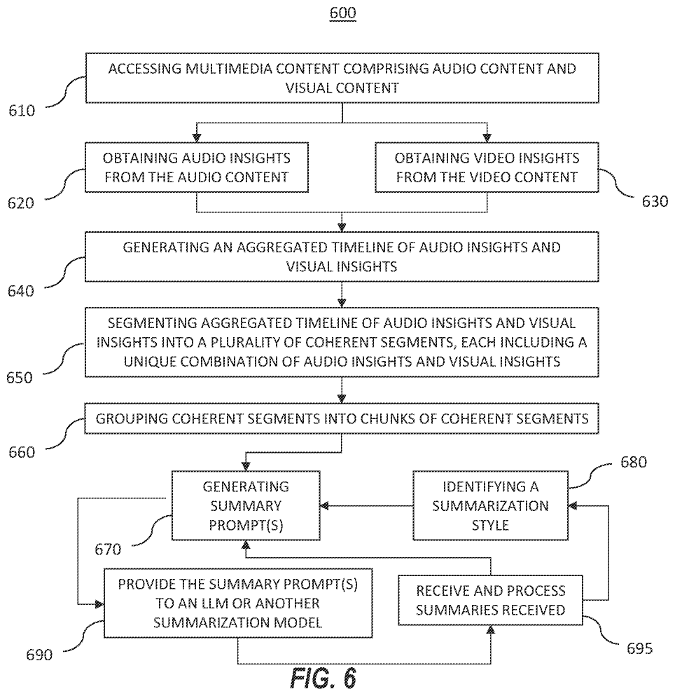

Attention is now directed to FIG. 6, which illustrates a flow diagram 600 of a plurality of acts associated with example methods for generating and using summary prompts to generate summaries of multimedia content based on visual insights and audio insights of the multimedia content.

The illustrated acts are implemented by a computer system having a processor and storage that stores computer-executable instructions that are executable by the processor to implement the functionality of the referenced acts.

The first illustrated act includes the computer system accessing multimedia content (act 610). This may include the system accessing a locally stored media file or a remotely stored media file. This may also include accessing a channel on which the multimedia content is streamed. The multimedia content includes any combination of audio content and image content, as previously described.

Next, the system applies one more machine learning model to the multimedia to obtain audio insights and video insights for the multimedia content. In particular, the system obtains audio insights from the audio content (act 620) and video insights from the video content (act 630), as previously described.

Next, the system generates an aggregated timeline of the audio insights and the visual insights (act 640) and segments this aggregated timeline into a plurality of coherent segments, each including a unique combination of audio insights and visual insights (act 650). These acts may be performed sequentially and/or concurrently.

Then, the system groups the coherent segments into chunks (act 660) based on the constraints of the model prompt size and/or another user's desired size metric. In some instances, the size constraint is hundreds of characters of text, but less than 1,000 characters of text. In other instances, the size constraint is thousands of characters of text, but less than 5,000 characters of text, or 10,000 characters of text, 20,000 characters of text, or another predefined number of characters.

The system generates a summary prompt for each chunk, incorporating the insights of the coherent segments of that respective chunk (act 670). The summary prompt generation also includes, optionally, the incorporation of an identified or selected summarization style that has been identified by the system (act 680).

Then, the summary prompts for each of the chunks are provided to an LLM or another summarization model (act 690) by entering the summary prompts into the input fields (interface prompts) of the model. Thereafter, the system receives the summaries that are returned from the model in response to providing the summary prompts to the model.

The response summaries can then be further processed and combined into a final comprehensive summary (act 695). This may also include generating new prompts based on the responsive summaries that are provided to the model (acts 670, 690), as previously described.

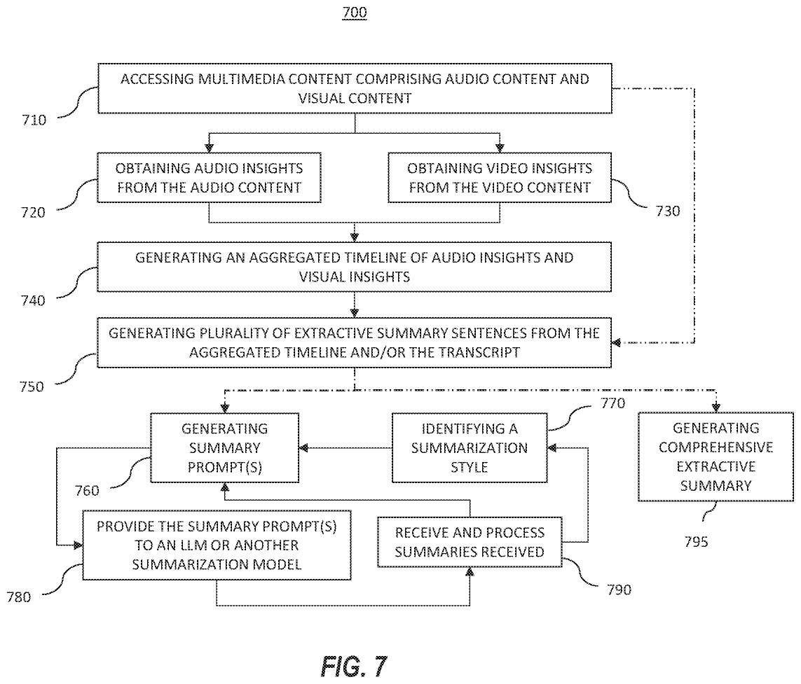

The flow diagram 700 of FIG. 7 is similar to the flow diagram 600 of FIG. 6. In particular, acts 710, 720, 730, 740, 760, 770, 780, and 790 are the same as acts 610, 620, 630, 640, 670, 680, 690 and 695 and will not, therefore, be further discussed at this point.

Unlike flow diagram 600, however, flow diagram 700 includes the act of generating a plurality of extractive summary sentences from the aggregated timeline and/or the transcript (act 750), as previously described. This flow diagram 700 also includes the generation of a comprehensive extractive summary (act 795), which has also been previously described.

It will be appreciated that the foregoing acts may be performed iteratively and with the same or different sequencing that is shown to accommodate different needs and desires. For example, it is possible to identify a summarization style (act 770) prior to generating the aggregated timeline (act 740) and even prior to accessing the multimedia content (act 710).

It will also be appreciated that the disclosed methods may be practiced by a computer system comprising a computer including one or more processors and computer-readable media such as computer memory. In particular, the computer memory may store computer-executable instructions that when executed by one or more processors cause various functions to be performed, such as the acts recited in the disclosed embodiments.

Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, embodiments of the disclosure can comprise at least two distinctly different kinds of computer-readable media: physical computer-readable storage media and transmission computer-readable media.

Physical computer-readable storage media includes random access memory (RAM), read-only memory (ROM), programmable read-only memory (EEPROM), compact disk read-only memory (CD-ROM), or other optical disk storage such as compact disks (CDs), digital video disks (DVDs), etc., magnetic disk storage or other magnetic storage devices, or any other hardware storage devices which can be used to store desired program code in the form of computer-executable instructions or data structures and which can be accessed by a general purpose or special purpose computer.

When information is transferred or provided over a network or another communications connection (either hardwired, wireless, or a combination of hardwired or wireless) to a computer, as described herein, the computer properly views the connection as a transmission medium. Transmission media can include a network and/or data links that can be used to carry or desired program code means in the form of computer-executable instructions or data structures and which can be accessed by a general purpose or special purpose computer. Combinations of the above are also included within the scope of computer-readable media.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a network interface card (NIC), and then eventually transferred to computer system RAM and/or less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating summary prompts from multimedia content, the method comprising:
accessing the multimedia content, the multimedia content comprising audio content and visual content;
obtaining audio insights from the audio content, the audio insights comprising at least one of (i) a coherent transcript that comprises textual representations of spoken utterances contained in the audio content and speaker identifications for the spoken utterances, or (ii) nonspeech sound labels corresponding to nonspeech sounds;
obtaining visual insights from the visual content, the visual insights including at least one of (i) text visualized in the visual content, (ii) object labels for objects visualized in the visual content, and (iii) identity labels for people represented in the visual content;
generating coherent segments of an aggregated timeline of the audio insights and the visual insights, the aggregated timeline comprising a temporal alignment of the audio insights and the visual insights, each of the coherent segments including a unique combination of audio insights and visual insights; grouping the coherent segments into a set of chunks based on a predetermined prompt size;
identifying a selected summary style that is selected from a plurality of different summary styles; and
generating a summary prompt for each chunk in the set of chunks based on (i) the audio insights and visual insights of the coherent segments of each chunk and (ii) the selected summary style.

2. The method of claim 1, wherein the method further comprises providing the summary prompt for each chunk to a model trained to generate summaries from summary prompts.

3. The method of claim 2, wherein the model comprises a large language model (LLM).

4. The method of claim 2, wherein the method further comprises obtaining a plurality of summaries from the model comprising a summary for each chunk and combining the plurality of summaries into a new summary prompt.

5. The method of claim 4, wherein the method further comprises providing the new summary prompt to the model and obtaining a new summary from the model in response to providing the new summary prompt to the model.

6. The method of claim 1, wherein the method further comprises generating the audio insights by at least performing speech-to-text and diarization processing on the audio content.

7. The method of claim 1, wherein the method further comprises generating the visual insights by (i) performing facial recognition and object recognition on the visual content, and (ii) removing duplicate visual insights identified when performing facial recognition and object recognition on the visual content.

8. The method of claim 1, wherein the method further comprises linking two temporally adjacent chunks in the set of chunks with a linking segment from the coherent segments by including the linking segment into both of the two temporally adjacent chunks.

9. A method for generating a summary of multimedia content, the method comprising:
accessing the multimedia content, the multimedia content comprising audio content and visual content;
obtaining audio insights from the audio content, the audio insights comprising at least one of (i) a coherent transcript that comprises textual representations of spoken utterances contained in the audio content and speaker identifications for the spoken utterances, or (ii) nonspeech sound labels corresponding to nonspeech sounds;
obtaining visual insights from the visual content, the visual insights including at least one of (i) text visualized in the visual content, (ii) object labels for objects visualized in the visual content, and (iii) identity labels for people represented in the visual content;
generating an aggregated timeline of the audio insights and the visual insights by temporally aligning the audio insights and the visual insights;
segmenting the aggregated timeline into coherent segments, each of the coherent segments including a unique combination of audio insights and visual insights;
grouping the coherent segments into a set of chunks based on a predetermined prompt size;
identifying a selected summary style that is selected from a plurality of different summary styles;
generating a summary prompt for each chunk in the set of chunks based on (i) the audio insights and visual insights of the coherent segments of each chunk and (ii) the selected summary style;
providing the summary prompt for each chunk to a model trained to generate summaries from summary prompts;
obtaining a plurality of summaries from the model comprising a separate summary for each summary prompt received in response to providing each summary prompt to the model; and
combining the plurality of summaries into a single summary.

10. The method of claim 9, wherein the combining the plurality of summaries into a single summary comprises (i) combining the plurality of summaries into a new summary prompt, (ii) providing the new summary prompt to the model, and (iii) obtaining a new summary comprising the single summary from the model in response to providing the new summary prompt to the model.

11. The method of claim 10, wherein the model comprises a large language model (LLM).

12. The method of claim 9, wherein the method further comprises generating the audio insights by at least performing speech-to-text and diarization processing on the audio content.

13. The method of claim 9, wherein the method further comprises generating the visual insights by (i) performing facial recognition and object recognition on the visual content, and (ii) removing duplicate visual insights identified when performing facial recognition and object recognition on the visual content.

14. The method of claim 9, wherein the method further comprises linking two temporally adjacent chunks in the set of chunks with a linking segment from the coherent segments by including the linking segment into both of the two temporally adjacent chunks.

15. A method for generating a summary of multimedia content, the method comprising:
accessing the multimedia content, the multimedia content comprising audio content and visual content;
obtaining audio insights from the audio content, the audio insights comprising at least one of (i) a coherent transcript that comprises textual representations of spoken utterances contained in the audio content and speaker identifications for the spoken utterances, or (ii) nonspeech sound labels corresponding to nonspeech sounds;
obtaining visual insights from the visual content, the visual insights including at least one of (i) text visualized in the visual content, (ii) object labels for objects visualized in the visual content, and (iii) identity labels for people represented in the visual content;
generating an aggregated timeline of the audio insights and the visual insights by temporally aligning the audio insights and the visual insights;
generating a plurality of extractive summary sentences from the aggregated timeline;
generating a summary prompt by combining the plurality of extractive summary sentences into the summary prompt;
providing the summary prompt to a model trained to generate summaries from summary prompts; and
obtaining a summary from the model based on the plurality of extractive summary sentences that is received in response to providing the summary prompt to the model.

16. The method of claim 15, wherein generating the summary prompt further comprises identifying a selected summary style that is selected from a plurality of different summary styles and including an identification of the selected summary style in the summary prompt.

17. The method of claim 15, wherein the model comprises a large language model (LLM).

18. The method of claim 15, wherein the method further comprises generating the audio insights by at least performing speech-to-text and diarization processing on the audio content.

19. The method of claim 15, wherein the method further comprises generating the visual insights by (i) performing facial recognition and object recognition on the visual content, and (ii) removing duplicate visual insights identified when performing facial recognition and object recognition on the visual content.

20. The method of claim 16, wherein the multimedia content comprises streaming content and wherein generating the aggregated timeline comprises generating the aggregated timeline for a portion of the multimedia content of a predetermined duration of time.
